(19) United States
(12) Patent Application Publication
(10) Pub. No.: US 2023/0283195 A1
(43) Pub. Date: Sep. 7, 2023

(54) METHOD OF CONTROLLING A QUASI RESONANT CONVERTER AND RELATED INDUCTION COOKTOP

(71) Applicant: WHIRLPOOL CORPORATION, BENTON HARBOR, MI (US)

(72) Inventors: Salvatore Baldo, Grotte (AG) (IT); Andrea Gallivanoni, Casorate Sempione (IT); Cristiano Vito Pastore, Comerio (IT); Andrea Zoppi, Turano Lodigiano (LO) (IT)

(73) Assignee: WHIRLPOOL CORPORATION, BENTON HARBOR, MI (US)

(21) Appl. No.: 18/116,137

(22) Filed: Mar. 1, 2023

(30) Foreign Application Priority Data
Mar. 2, 2022 (EP) 22159837.8

(51) Int. Cl. H02M 7/217; H05B 6/12

(52) U.S. Cl. CPC H02M 7/217; H05B 6/1209; H02M 1/44

(57) ABSTRACT

A ticking noise that can be heard when the QR converter is operated to deliver a power level smaller than the minimum power level for having a soft-switching can be due to the fact that during the OFF interval there is no power delivery and the DC-bus capacitance is charged at the peak of rectified main line voltage. This drawback may be overcome by discharging purposely the DC-bus capacitor during an OFF interval of the QR converter until the DC-bus capacitor is substantially discharged when a new ON interval of the QR converter is started.

### CROSS-REFERENCE TO RELATED APPLICATIONS

This application claims priority to European Patent Application No. 22159837.8, filed on 2 Mar. 2022, entitled “METHOD OF CONTROLLING A QUASI RESONANT CONVERTER AND RELATED INDUCTION COOKTOP,” the disclosure of which is hereby incorporated herein by reference in its entirety.

### BACKGROUND OF THE DISCLOSURE

The present disclosure relates to voltage converters and more in particular to methods of controlling a quasi resonant (“QR”) converter usable for realizing induction cooktops and for induction heating items of cookware placed above a heating coil powered by the QR converter. A QR converter may generate a ticking noise and an output switch associated with the QR converter may dissipate a suboptimal amount of power.

### SUMMARY

The present disclosure addresses those issues, among other ways, by discharging purposely a DC-bus capacitor during an OFF interval of the QR converter so that the DC-bus capacitor is substantially discharged when a new ON interval of the QR converter is started. For example, a control line can be included that senses the voltage on a DC-bus and turns ON/OFF a controlled output switch S of the QR converter with a train of pulses so that the voltage on the DC-bus tracks a falling edge of a half-wave of a rectified AC input voltage. For simplicity of language a “DC-bus capacitor” is mentioned herein. However, it should be understood that multiple DC-bus capacitors could be utilized instead of a single DC-bus capacitor.

### BRIEF DESCRIPTION OF THE DRAWINGS

In the drawings:

FIG. 1 is a basic circuit diagram of a QR converter powering a load connected to the rectifying stage through a controlled output switch;

FIG. 2 depicts a time graph of the control signal of the output switch of the QR converter of FIG. 1 when the power to be supplied to the load is smaller than a minimum power value for having a soft-switching;

FIG. 3 is a circuit diagram of a QR converter with an output switch controlled according to a method of this disclosure;

FIG. 4 is a time graph of the main signals and of the control pulses applied to the output switch for discharging the DC-bus capacitor of the QR converter of FIG. 3 at the end of an OFF interval immediately before the beginning of an ON interval;

FIG. 5 is a detail view of the time graph of FIG. 4 during the discharge of the DC-bus capacitor of the QR converter during an OFF interval;

FIG. 6 is a circuit diagram of a QR converter with an output switch controlled by a control line that implements a method of this disclosure;

FIG. 7 is a time graph of the main signals and of the control pulses applied to the output switch for discharging the DC-bus capacitor of the QR converter of FIG. 6 during an OFF interval every time the DC-bus capacitor is charged; and

FIG. 8 is a detail view of the time graph of FIG. 7 during the discharge of the DC-bus capacitor of the QR converter during an OFF interval.

### DETAILED DESCRIPTION

Cooking appliances, in particular induction cooking appliances, can have at least one main switching unit to supply induction heating elements with a supply voltage through actuation of a main energy supply, and an energy storage unit, in particular a bus capacitor, which is provided in particular for signal smoothing through the charging of an energy storage unit with a charge potential.

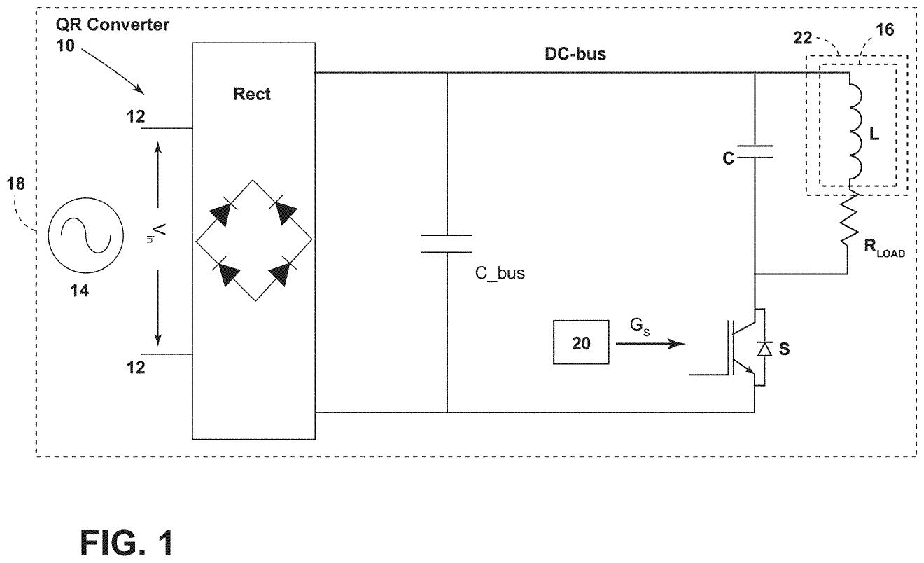

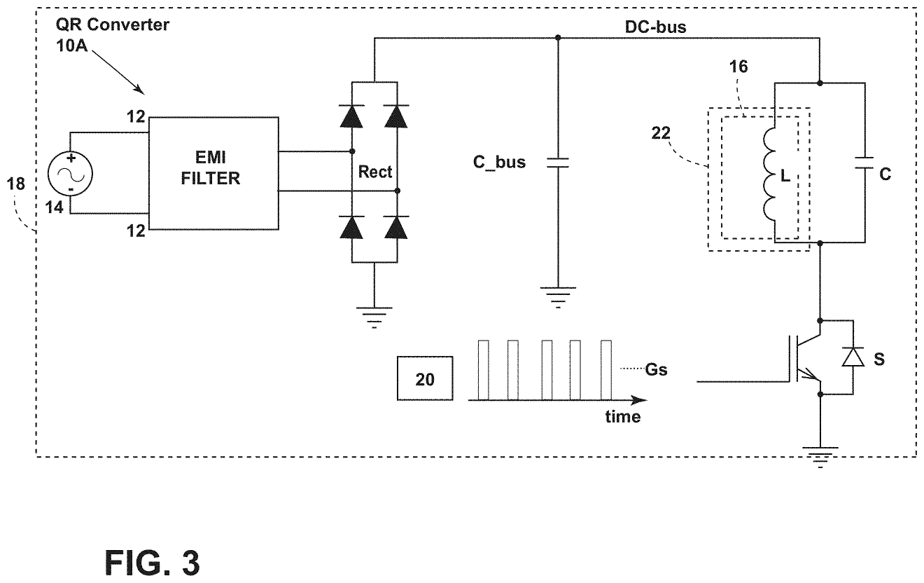

QR converters 10 and 10A are shown in FIGS. 1 and 3, respectively. The QR converters 10, 10A include:
a rectifier stage Rect having input alternating current (“AC”) terminals 12, for receiving an AC voltage 14 to be rectified, and a DC-bus having a high-side line for making available a direct current (“DC”) voltage on the DC-bus between the high-side line and the low-side line, wherein the DC voltage is generated as a rectified replica of the AC voltage received at the input AC terminals;
a DC-bus capacitor connected between the high-side line and the low-side line;
a L-C resonant pair connected between the high-side line and an intermediate node, configured to be magnetically coupled with a load (RLOAD). For example, the inductive component L of the L-C resonant pair may be a heating coil 16 of an induction cooktop 18, and the capacitive component C of the resonant pair may be a capacitor dimensioned to determine a resonance frequency of the L-C resonant pair;
a controlled output switch S connected in series with the L-C resonant pair between the intermediate node and the low-side line; and
a control unit 20 configured to turn on/off the controlled output switch S.

QR converter 10A of FIG. 3 comprises an optional electromagnetic interference filter EMI FILTER, in order to prevent electromagnetic interference from the QR converter 10A.

QR converters 10, 10A are a particular type of switching unit that can be used as AC current generators for the induction cooktop 18. Such converters use just one solid state switch and only one resonant capacitor to generate a variable frequency/variable amplitude current to feed the induction heating coil 16. When properly designed and matched with their load, these QR converters 10, 10A can operate in the so called “soft-switching” mode, which consists in having the switching device commutating when either the voltage across it and/or the current flowing through it are null.

A drawback the QR converters 10, 10A lies in the range of output power being achievable in the Soft-Switching regime. In particular, when the output power being regulated falls below a given limit, the inverter fails in operating in soft-switching mode, leading to an increase in thermal losses (hard-switching) and Electromagnetic Interference (“EMI”). Those limitations can lead to a relatively low regulation range, which is defined as the ratio between maximum achievable power (limited by maximum voltage across the controlled output switch S) and the minimum achievable power (limited by the losses for hard-switching at turn on). This situation can be an issue when a user wants to supply low power to a cookware 22.

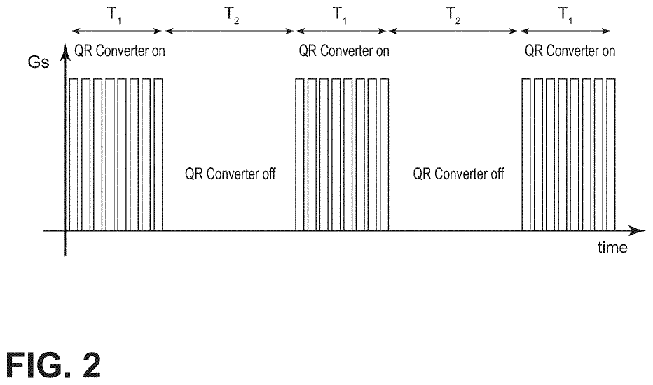

One way to overcome the aforementioned limitation for the QR converters 10, 10A is to operate the inverter in the so-called burst-mode or ON-OFF mode (as shown in FIG. 2), consisting in operating the QR converters 10, 10A for some amount of time T1, during which several charging phases and discharging phases occur, at the minimum power level adjustable according to soft switching conditions, and switching it off for another amount of time T2. By cyclically alternating over time the two intervals, the average power delivered to the load (e.g., RLOAD) can be calculated by multiplying the duty ratio T1/(T1+T2) by the minimum power limit (the minimum settable power to have soft switching).

For example, if the user wants to supply 100 W and the minimum power to have soft-switching is 700 W, the system can operate in the ON/OFF mode, in which the 700 W is supplied for a short time interval T1, and for the remainder of the time interval T2 the QR converter 10, 10A is kept off, to obtain an average power delivery of 100 W. As mentioned, however, two things can happen:—a ticking acoustic noise from the cookware 22 can be produced; and—the output switch S produces dissipated power (high hard-switching) at the first activation after the T2 interval.

Stated another way, during operation of the QR converter 10, 10A, a ticking acoustic noise can be generated, for example when the QR converter 10, 10A is delivering to the cookware 22 a power lower than the minimum power required for the QR converter 10, 10A to operate in the soft-switching mode. In this situation, and other similar conditions, energy is transferred to the cookware 22 in a short interval of time, such interval being comparable to the switching time of the controlled output switch S. For example, this can happen when the DC-bus capacitance is charged at the peak of the rectified mains line voltage (e.g. 325 V for nominal RMS line voltage of 230 V), and the controlled output switch S is turned on for the first time after a long period of being kept off. For example, if the QR converter 10, 10A is kept inactive for at least 10 ms, the first time it is turned on again after that period has elapsed this situation will occur. In those same conditions, there is also a large amount of power dissipation occurring in the output switch S, the so-called hard-switching condition. This can also occur every time the output switch S is turned ON for the first time, after the main relay closure.

Another situation where ticking noise can occur is during the so-called “pan detection” operation, that is when the presence of the cookware 22 on the induction heating cooktop 18 is detected. The detection of the cookware 22 can be accomplished by feeding power to the induction heating coil 16 and by assessing at least an electrical parameter of the QR converters 10, 10A of the induction heating cooktop 18 which is modified when cookware 22 is placed on one of the induction heating coils 16. Given that one method to perform the pan detection operation is to stimulate the induction heating coils 16 with short PWM pulses, and record the value of the electrical parameter of the QR converters 10, 10A, if the cookware 22 detection is operated when the DC-bus capacitor is charged, this could typically cause the noise to be produced.

The QR converter of this disclosure, including QR converters 10, 10A, may be equipped with a control line that senses the voltage on the DC-bus and turns ON/OFF the controlled output switch S of the QR converter with a train of pulses so that the voltage on the DC-bus tracks a falling edge of a half-wave of the rectified AC input voltage. Doing that presents two technical advantages: 1) it eliminates the occurrences of the ticking noise, thus resulting in a more pleasing experience for the user; and 2) it reduces the power dissipation on the controlled output switch S. In other words, at least part of these drawbacks are overcome according to this disclosure by discharging purposely the DC-bus capacitor during an OFF interval of the QR converter 10, 10A so that the DC-bus capacitor is substantially discharged when a new ON interval of the QR converter 10, 10A is started. According to an aspect, the DC-bus capacitor may be discharged during an OFF interval by closing the output switch S of the QR converter 10, 10A.

To elaborate, in reference particularly to FIG. 3, the QR converter 10A, may be controlled so as to prevent the generation of the ticking noise that can be heard when the QR converter 10A is operated to deliver a power level smaller than the minimum power level for having a soft-switching, or when a “pan detection” operation is carried out before powering the induction coil(s) surmounted by the cookware 22. This may be done by carrying out, before an ON time interval T1 of the QR converter 10A begins during which the load coupled with the L-C resonant pair is powered by the QR converter 10, the step of operating ON/OFF the controlled output switch S of the QR converter 10A until the DC voltage on the capacitance C_bus of the DC-bus between the high-side line and the low-side line is decreased below a minimum nominal value, at which the above discussed drawbacks are practically negligible. By discharging the capacitance C_bus of the DC-bus before powering the load, the DC voltage is substantially null when the ON time interval T1 begins and thus a soft-switching, or a “low hard-switching” (i.e. a hard-switching with a relatively small voltage on the output switch S) is performed because the voltage across the controlled output switch S is at most equal to said minimum nominal value when the output switch S is turned on.

Discharging the capacitance of the DC-bus before powering the load is an efficient technique for preventing the generation of the ticking noise when the QR converter 10, 10A is operated by periodically alternating ON time intervals T1, during which a load coupled with the L-C resonant pair is powered by the QR converter 10, 10A, to OFF time intervals T2, during which the load is not powered by the QR converter 10, 10A. The ticking noise is typically generated when the QR converter 10, 10A is operated to deliver an average power smaller than the minimum power that can be delivered to the load while maintaining the output switch S in soft-switching operation. In these situations, shown for example in FIG. 2, during ON time intervals T1 the controlled output switch S is driven ON/OFF at a nominal switching frequency of the QR converter 10, 10A and with a duty-cycle corresponding to said minimum power, whereas during OFF time intervals T2 the controlled output switch S is kept OFF, wherein a duration of an ON time interval T1 and a duration of a subsequent OFF time interval T2 are adjusted so as an average power delivered to the load is a fraction of the minimum power.

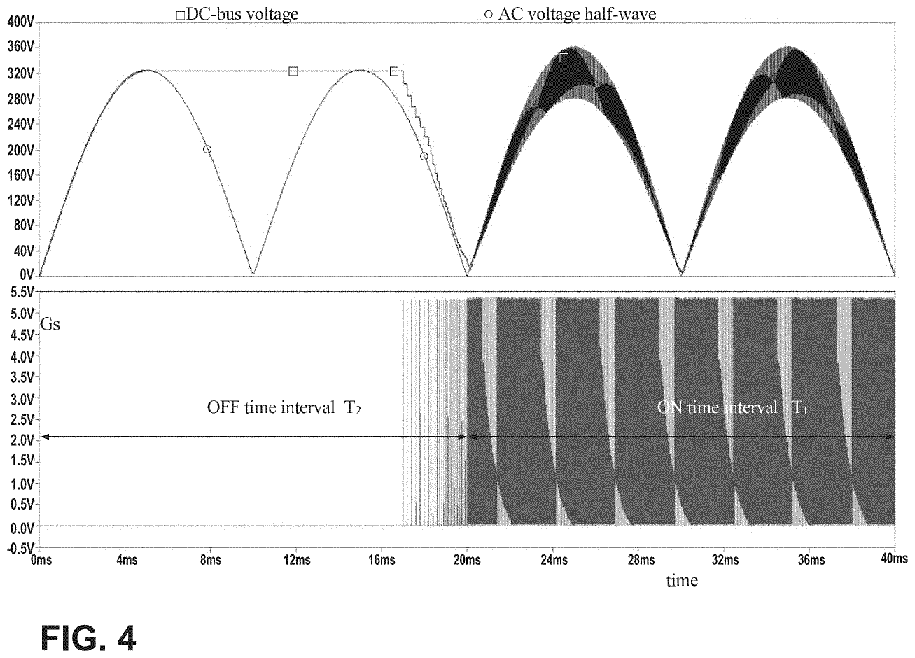

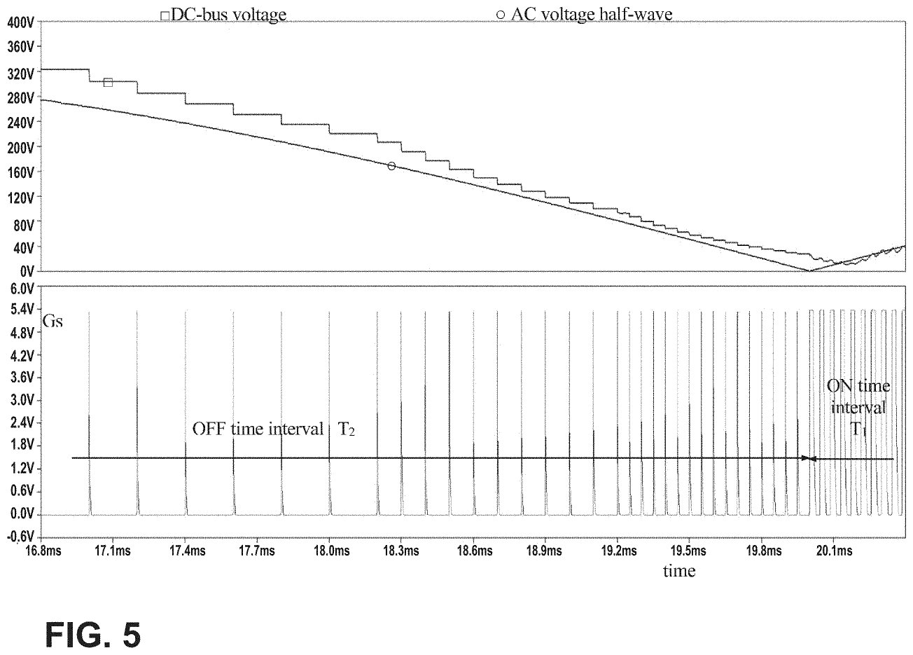

The ticking noise may be avoided by switching ON/OFF the controlled output switch S in such a manner as the DC voltage on the capacitance of the DC-bus between the high-side line and the low-side line is nullified before an ON time interval T1 begins, as shown in the time graphs of FIGS. 4 and 5. This technique does not require additional components and may be implemented in QR converter 10, 10A by properly driving the controlled output switch S before powering the load.

Making reference to the exemplary time graphs of FIGS. 4 and 5, the pulse duration for the command signal of the output switch S can range between 200 ns and 300 ns with a period between 50 μs and 300 μs. The duration of the entire train of pulses depends on the value of the DC-bus capacitance C_bus to be discharged. With a capacitance C_bus in the order of a few μF, typically after a pulse train of 3 ms the DC-bus capacitance C_bus is completely discharged. The system comes from an OFFinterval in which the DC-bus capacitance C_bus is charged. Before starting the delivery, the discharge pattern begins. It is important to notice that, in order for this mode of operation to be effective, the pulse train must begin after a peak of the mains line voltage, otherwise any decrease in the DC-bus voltage obtained by this method would then later be reverted by the operation of the voltage rectifier Rect. In this example, the DC-bus capacitance C_bus has a value of 5 μF, and the discharge pattern starts 3 ms before the power delivery. In this specific case with a DC-bus capacitance of 5 μF, the pattern is made of 6 pulses with a duration of 250 ns, the pulses being repeated every 200 μs, then 10 pulses of the same duration every 100 μs and finally 16 pulses of the same duration every 50 μs. In general, the pattern and the duration of pulses may be adjusted depending on the DC-bus capacitance in order to discharge it into a maximum time interval established by users according to the needs.

With the exemplified pattern the discharge is almost linear, obtaining a residual voltage on the DC-bus of about 20 V at the beginning of the ON time interval. With a voltage of about 20 V across the output switch S, the power delivery can occur without generating an acoustic noise and in a low hard switching condition (nonnull initial voltage of relatively small value).

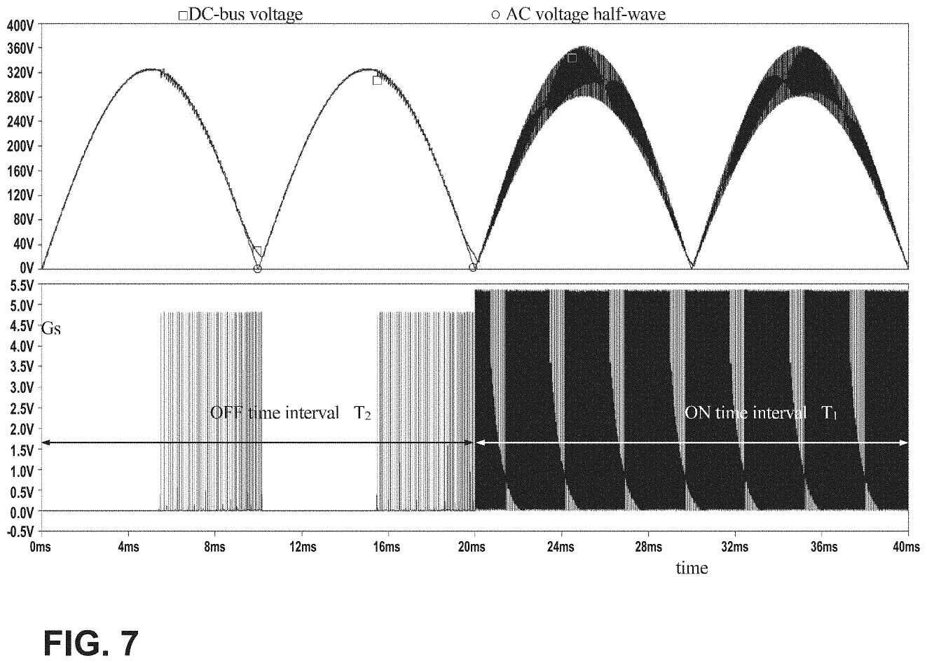

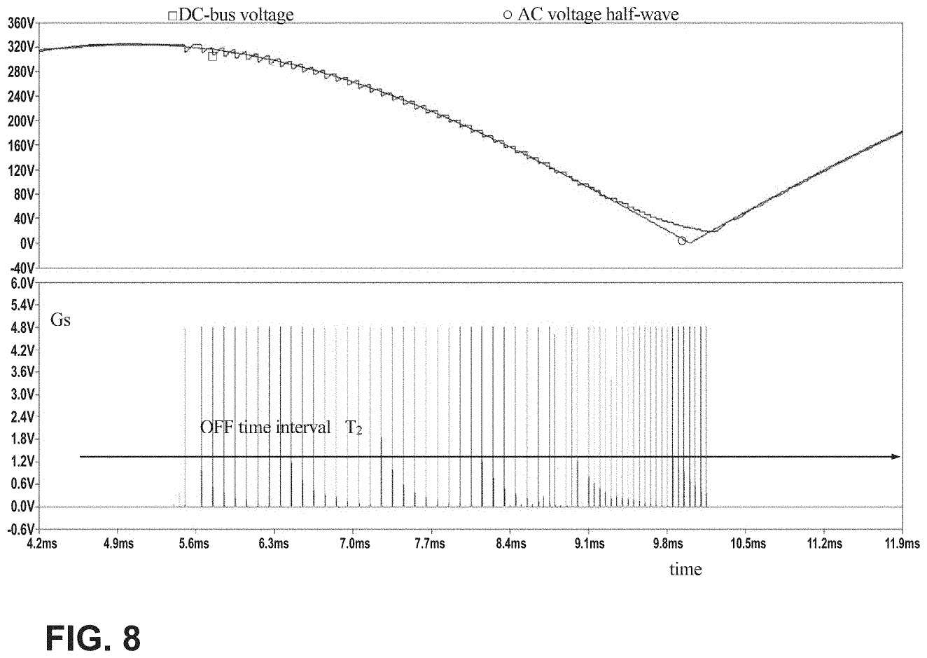

According to an aspect of this disclosure, the QR converter 10, 10A may be equipped with a comparator configured to compare the DC voltage on the capacitance of the DC-bus with a trailing profile of the rectified replica of a half-wave of the AC voltage received at the input AC terminals of the rectifier stage Rect, and configured to generate an error signal corresponding to a difference between the trailing edge of the rectified replica and the DC voltage on the DC-bus. The controller 20 is then configured to switch ON/OFF the controlled output switch S with a discharge duty-cycle and at a discharge switching frequency determined as a function of the error signal so as to make the DC voltage on the DC-bus track the trailing edge of the rectified replica of a half-wave of the AC voltage, until the DC voltage on the DC-bus capacitor is nullified, as shown in the exemplary time graphs of FIGS. 7 and 8.

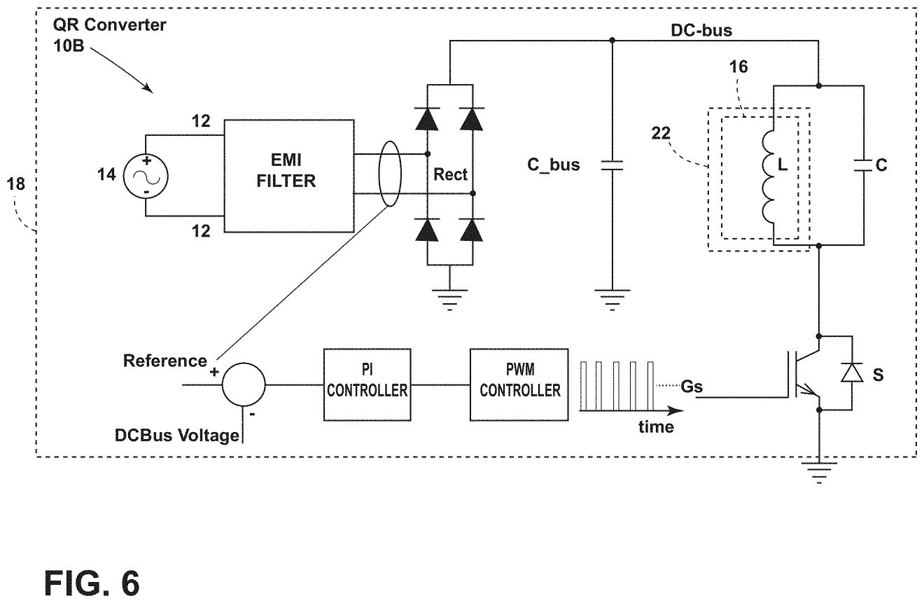

According to an optional aspect, as shown in FIG. 6, QR converter 10E3 may also have a proportional-integral (PI) controller (PI CONTROLLER), configured to generate a proportional-integral replica of the error signal, and the controller (PWM CONTROLLER) may be configured to determine the discharge duty-cycle and the discharge switching frequency of the train of pulses that control the controlled output switch S, in order to make the DC voltage on the DC-bus track the trailing edge of the rectified replica of a half-wave of the AC voltage, as a function of the proportional-integral replica of the error signal. It is to be understood that the above-mentioned PI controller is used only as an exemplary embodiment, and that persons skilled in the art can readily understand the possibility of resorting to controllers of different kinds. It is also to be understood that, while in FIG. 6 the error signal calculation, the PI controller, and the PWM controller are shown as individual parts, they can easily and advantageously be integrated into the main microcontroller used to control the usual operation of the converter. Referring to the exemplary time graphs of FIGS. 7 and 8, depending on the DC-bus capacitance value, the pulses pattern changes according to the response of the PI controller. FIG. 7 shows an example in which, using a PI control, a 5 μF capacitance C_bus is discharged, obtaining a DC-bus voltage that follows the mains half-wave. In this case the minimum pulses period may be for example about 50 μs and the duration of the pulse may be between 10 ns and 250 ns (FIG. 8). For different values of the capacitance C_bus, the duration of the time interval during which a burst of pulses is generated, as well as the duration of each pulse, may be varied accordingly.

The QR converters 10, 10A, 10B presented above may be used to realize the induction cooktop 18, for heating the item of cookware 22, by using the induction heating coil 16 as the inductive component of the L-C resonant pair, configured to be magnetically coupled with the item of cookware 22 to be heated.

What is claimed is:

1. A method of controlling a quasi resonant converter, the quasi resonant converter comprising:
a rectifier stage having input AC terminals, for receiving an AC voltage to be rectified, and a DC-bus having a high-side line for making available a DC voltage on the DC-bus between the high-side line and the low-side line, the DC voltage being generated as a rectified replica of the AC voltage received at the input AC terminals;
a DC-bus capacitor connected between the high-side line and the low-side line;
a L-C resonant pair connected between the high-side line and an intermediate node, wherein the L-C resonant pair is configured to be magnetically coupled with a load;
a controlled output switch connected in series with the L-C resonant pair between the intermediate node and the low-side line; and
a control unit configured to turn on/off said controlled output switch;
the method comprising:
before an ON time interval (T₁) of the quasi resonant converter begins, during which a load coupled with the L-C resonant pair is powered by the quasi resonant converter, operating on/off the controlled output switch (S) to nullify the DC voltage on the DC-bus between the high-side line and the low-side line, until the DC voltage is null when the ON time interval (T₁) begins.

2. The method of claim 1 further comprising:
periodically alternating ON time intervals (T₁) of the quasi resonant converter, during which the load coupled with the L-C resonant pair is powered by the quasi resonant converter, to OFF time intervals (T₂) of the quasi resonant converter, during which the load is not powered by the quasi resonant converter; and
during the ON time intervals (T₁) of the quasi resonant converter, driving on/off the controlled output switch (S) at a nominal switching frequency of the quasi resonant converter and with a duty-cycle corresponding to a minimum power to be delivered to the load by the quasi resonant converter to perform a soft-switching of the controlled output switch, wherein a duration of an ON time interval of the ON time intervals (T₁) and a duration of a subsequent OFF time interval of the OFF time intervals (T₂) are adjusted so that an average power delivered to the load is a fraction of the minimum power.

3. The method of claim 1 further comprising:
during the OFF time interval (T₂) of the quasi resonant converter:
comparing the DC voltage on the DC-bus between the high-side line and the low-side line with a trailing edge of the rectified replica of a half-wave of the AC voltage received at the input AC terminals of the rectifier stage, generating an error signal corresponding to the difference between the trailing edge of the rectified replica and the DC voltage on the DC-bus; and
switching on/off said controlled output switch with a discharge duty-cycle and at a discharge switching frequency determined as a function of the error signal so as to make the DC voltage track the trailing edge of the rectified replica of a half-wave of the AC voltage, until the DC voltage between said high-side line and the low-side line is nullified.

4. The method of claim 3, further comprising determining the discharge duty-cycle and the discharge switching frequency as a function of a proportional-integral replica of the error signal.

5. The method of claim 1 further comprising:
before an ON time interval begins of the quasi resonant converter, switching on/off the controlled output switch (S) until the DC voltage on the DC-bus between the high-side line and said low-side line is nullified.

6. The method of claim 1, wherein
the method is performed to induction heat an item of cookware with an induction cooktop.

7. A quasi resonant converter comprising:
a rectifier stage having input AC terminals, for receiving an AC voltage to be rectified, and a DC-bus having a high-side line for making available a DC voltage on the DC-bus between the high-side line and the low-side line, the DC voltage being generated as a rectified replica of the AC voltage received at the input AC terminals;
a L-C resonant pair connected between the high-side line and an intermediate node, wherein the L-C resonant pair is configured to be magnetically coupled with a load;
a controlled output switch connected in series with the L-C resonant pair between the intermediate node and the low-side line; and
a control unit comprising a comparator configured to compare the DC voltage on the DC-bus on the said high-side line and the low-side line with a trailing edge of the rectified replica of a half-wave of the AC voltage received at the input AC terminals of the rectifier stage,
wherein, the control unit is configured:
to generate an error signal corresponding to a difference between the trailing edge of the rectified replica and the DC voltage on the DC-bus; and
to switch on/off said controlled output switch with a discharge duty-cycle and at a discharge switching frequency determined as a function of the error signal so as to make the DC voltage track the trailing edge of the rectified replica of the half-wave of the AC voltage, until the DC voltage between the high-side line and the low-side line is nullified.

8. The quasi resonant converter of claim 7 further comprising:
a proportional-integral controller configured to generate a proportional-integral replica of the error signal,
wherein the control unit is configured to determine the discharge duty-cycle and the discharge switching frequency as a function of the proportional-integral replica of the error signal.

10. An induction cooktop comprising:
an induction heating coil positioned to be magnetically coupled with an item of cookware to be heated upon the induction heating coil; and
a quasi resonant converter comprising:
a rectifier stage having input AC terminals, for receiving an AC voltage to be rectified, and a DC-bus having a high-side line for making available a DC voltage on the DC-bus between the high-side line and the low-side line, the DC voltage being generated as a rectified replica of the AC voltage received at the input AC terminals,
a DC-bus capacitor connected between the high-side line and the low-side line;
a L-C resonant pair connected between the high-side line and an intermediate node, wherein an inductive component of the L-C resonant pair is the induction heating coil,
a controlled output switch connected in series with the L-C resonant pair between the intermediate node and the low-side line, and
a control unit configured to turn on/off the controlled output switch;
wherein, the control unit is further configured to discharge capacitance of the DC-bus capacitor during an OFF interval of the quasi resonant converter so that the DC-bus capacitor is substantially discharged when a new ON interval of the QR converter is started.

11. The induction cooktop of claim 10, wherein
the quasi resonant converter does not make an audible ticking sound when the new ON interval of the QR converter is started.

12. The induction cooktop of claim 10, wherein
the quasi resonant converter does not make an audible ticking sound when the power to be supplied to the item of cookware is smaller than a minimum power for having a soft-switching.

13. The induction cooktop of claim 10, wherein
the control unit is in communication with the DC-bus, and
the control unit is further configured to turn on/off the controlled output switch with a train of pulses so that the voltage on the DC-bus tracks a falling edge of a half-wave of the rectified replica of the AC voltage.

14. The induction cooktop of claim 13, wherein
the control unit is further configured to sense the DC voltage on the DC-bus.

15. The induction cooktop of claim 13, wherein
the control unit is further configured so that each pulse of the train of pulses has a duration within a range of from 200 ns and 300 ns, and a period between pulses within a range of from 50 μs to 300 μs.

16. The induction cooktop of claim 10, wherein
the control unit is further configured to discharge the DC-bus capacitor during an OFF interval of the quasi resonant converter by closing the controlled output switch of the quasi resonant converter.

17. The induction cooktop of claim 10, wherein
the quasi resonant converter further comprises a comparator in communication with the control unit configured (i) to compare the DC voltage of the DC-bus with a trailing profile of the rectified replica of the half-wave of the AC voltage and (ii) to generate an error signal corresponding to a difference between the trailing edge of the rectified replica of the half-wave of the AC voltage and the DC voltage of the DC-bus, and
the control unit is further configured to switch on/off the controlled output switch with a discharge duty-cycle and at a discharge switching frequency determined as a function of the error signal so as to make the DC voltage on the DC-bus track the trailing edge of the rectified replica of the half-wave of the AC voltage, until the DC voltage on the DC-bus is substantially nullified.

18. The induction cooktop of claim 10, wherein
the quasi resonant converter further comprises:
a comparator in communication with the controller configured (i) to compare the DC voltage of the DC-bus with a trailing profile of the rectified replica of the half-wave of the AC voltage and (ii) to generate an error signal corresponding to a difference between the trailing edge of the rectified replica of the half-wave of the AC voltage and the DC voltage of the DC-bus, and
a proportional-integral controller configured to generate a proportional-integral replica of the error signal and
the control unit is configured to determine the discharge duty-cycle and the discharge switching frequency of the train of pulses that control the controlled output switch S, in order to make the DC voltage on the DC-bus track the trailing edge of the rectified replica of the half-wave of the AC voltage, as a function of the proportional-integral replica of the error signal.

19. The induction cooktop of claim 10, wherein
the control unit is further configured:
to periodically alternate ON time intervals (T₁) of the quasi resonant converter, during which the item of cookware coupled with the L-C resonant pair is powered by the quasi resonant converter, to OFF time intervals (T₂) of the quasi resonant converter, during which power is not delivered to the item of cookware; and
during the ON time intervals (T₁) of the quasi resonant converter, to drive on-off the controlled output switch at a nominal switching frequency of the quasi-resonant converter and with a duty-cycle corresponding to a minimum power to be delivered to the item of cookware by the quasi resonant converter to perform a soft-switching of the controlled output switch, wherein a duration of an ON time interval of the ON time intervals (T₁) and a duration of a subsequent OFF time interval of the OFF time intervals (T₂) are adjusted so that an average power delivered to the item of cookware is a fraction of the minimum power.

20. The induction cooktop of claim 10, wherein
the quasi resonant converter further comprises an electromagnetic filter to reduce electromagnetic interference from the quasi-resonant converter.
